(19) United States
(12) Patent Application Publication
(10) Pub. No.: US 2014/0272851 A1
(43) Pub. Date: Sep. 18, 2014

(54) METHOD OF WORKING WITH THE BODY, AND RELATED TEACHING METHOD

(71) Applicant: David A. Reavy, Chicago, IL (US)

(72) Inventor: David A. Reavy, Chicago, IL (US)

(21) Appl. No.: 13/844,681

(22) Filed: Mar. 15, 2013

(51) Int. Cl. G09B 19/00

(52) U.S. Cl. CPC G09B 19/003
USPC 434/247

(57) ABSTRACT

The present invention is directed toward a method of working with a subject's body comprising evaluating the upper and/or lower body with a series of defined steps. The invention also includes a method for teaching the method of working with the body.

### CROSS-REFERENCE TO RELATED APPLICATIONS

This application is related to, claims priority from, and incorporates by reference in its entirety, copending US provisional application entitled “ACTIVATION AND/OR TARGETED EXERCISES”, filed Mar. 15, 2013.

### FIELD OF INVENTION

The present invention relates to a method for working with a subject's body by evaluating aspects of its musculature and removing restrictions therein, and a method for training such.

### BACKGROUND

Skeletal muscles in the body aid in movement, support posture, and engage in other activities. For a muscle to function properly, and in particular at its maximum force, the muscle must be able to relax and assume its correct resting length and tension level. Correct resting length and tension are also important in optimal joint function, to achieve an equal (and/or normal) amount of muscular force needed to keep a bone centered in its relevant joint during motion. For instance, the quadriceps and hamstrings generally act in opposition, one contracting to straighten the knee joint; the other, to flex it. If the quadriceps or hamstrings pull more than the other, whether in directly opposing directions or in different directions, then the muscles may pull the joint accordingly and cause problems with the knee.

If a muscle contracts and cannot relax fully, remaining at least partially contracted over time, it becomes “tight”, or restricted. The restricted muscle cannot shorten enough or lengthen enough to provide full strength, and can become resistant to movement. As the restricted muscle is no longer functioning properly, the body compensates by using the muscle less, or avoiding using the muscle entirely. Instead, the body uses other muscles that may achieve or help achieve the same or similar result, albeit less efficiently. The underuse of the restricted muscle and overuse of the compensating muscle may cause local imbalance through misalignment as well as misalignment in other parts of the body, as joints and bones and other muscles are pulled and stretched away from their normal positions, limiting their range of motion. Overall imbalance of the body may occur, as muscles that are restricted on one side of the body may not necessarily be restricted on the other side. Imbalance may occur for instance in any plane of motion (for instance, sagittal, transverse, coronal, rotation).

Muscles may become restricted and the body imbalanced for a variety of reasons, including for instance normal wear-and-tear; biomechanical problems (structural problems in the muscle itself), neuromuscular problems (difficulty in communication between a muscle and neural tissue); repetitive use or movement (e.g. exercise such as running, sport activities such as kicking a football); injury; and/or improper or lack of movement (e.g. poor posture or prolonged sitting). Activities performed in proper form help the body stay balanced by reinforcing the most efficient use of muscles; activities performed in improper form can cause different sides of the body to adjust in different ways, ultimately imbalancing the body. Postural changes may lead to instability of joints, which requires other muscles to increase their workload. Muscle restrictions may also occur at the musculotendon junction, for instance by an overused tendon, which may inhibit the activity of an e.g. antagonistic muscle.

Imbalance in the body may make the body more prone to injury, causing short term discomfort and inactivity, possibly extending into the long term to result in a sedentary lifestyle. Balancing the body can increase efficiency of movement, avoid injuries associated with restricted muscles, and promote a more active and therefore more healthy and happy lifestyle for a given person. When muscles are used properly, the body's joints are properly aligned and less likely to be injured by, for instance, absorbing more force than they are built to absorb. If injury does occur, it is less likely to be severe and more likely to heal more quickly. Achieving a body in balance is therefore a desirable goal.

### SUMMARY OF INVENTION

The present invention relates to a method of working with a subject's body, comprising the steps of evaluating at least one of the subject's upper body and the subject's lower body; said evaluating comprising the steps of (a) performing tests on a subject, wherein in each test the subject assumes a test position and a tester then attempts to move the subject from the test position, and then (b) considering the subject's ability to maintain the test position. The tests for evaluating the subject's lower body comprise (i) a supine bilateral hip abduction test, (ii) a supine straight leg raise test, (iii) a prone straight leg raise test, and (iv) a side-lying leg raise test, as well as preferably (v) a knee flexion test. Tests for evaluating the subject's upper body comprise (i) a supine shoulder adduction test, (ii) a supine horizontal shoulder adduction test, (iii) a supine elbow flexion test, (iv) a side lying horizontal abduction test, (v) a side lying shoulder abduction test, and (vi) a prone shoulder horizontal abduction test and a prone elbow extension test.

The present invention also relates to a method for training how to use the above method, and in particular how to restore or maintain balance of a subject's body. The present invention relates to a method for working with a subject's body, to evaluate the state of its musculature and where possible identify and remove muscle restrictions. Preferably, the method also provides for the identification of one or more true weaknesses in the body, and for the strengthening of such weaknesses, most preferably until the body is balanced and maintained in balance. Upper and lower body tests help achieve a proper pelvic and scapular alignment, which in turn help achieve a body in balance.

### BRIEF DESCRIPTION OF THE DRAWINGS

FIG. 1 shows an illustration of the Supine Bilateral Hip Abduction Test of the present invention.

FIG. 2 shows an illustration of the Supine Straight Leg Raise Test of the present invention.

FIG. 3 shows an illustration of the Prone Straight Leg Raise Test of the present invention.

FIG. 4 shows an illustration of the Side-Lying Leg Raise Test of the present invention.

FIG. 5 shows an illustration of the Knee Flexion Test of the present invention.

FIG. 6A shows an illustration of a foot in a neutral position.

FIG. 6B shows an illustration of a rear foot eversion according to the Ankle Test of the present invention.

FIG. 6C shows an illustration of a rear foot inversion according to the Ankle Test of the present invention.

FIG. 7A shows an illustration of a mid-foot eversion according to the Mid-Foot Test of the present invention.

FIG. 7B shows an illustration of a mid-foot inversion according to the Mid-Foot Test of the present invention.

FIG. 8A shows an illustration of a fore-foot eversion of the Fore-Foot Test of the present invention.

FIG. 8B shows an illustration of a fore-foot inversion of the Fore-Foot Test of the present invention.

FIG. 9 shows an illustration of the Supine Shoulder Adduction Test of the present invention.

FIG. 10 shows an illustration of the Supine Horizontal Shoulder Adduction Test of the present invention.

FIG. 11 shows an illustration of the Supine Elbow Flexion Test of the present invention.

FIG. 12 shows an illustration of the Side Lying Range of Motion Tests for Shoulder Abduction of the present invention.

FIG. 13 shows an illustration of the Prone Shoulder Horizontal Abduction Test of the present invention.

FIG. 14 shows an illustration of the Prone Elbow Extension Test of the present invention.

FIG. 15 shows an illustration of the Shoulder Flexion Test of the present invention.

FIG. 16 shows an illustration of the Abdominal Test of the present invention.

FIG. 17 shows an illustration of a VMO Activation exercise.

FIGS. 18A and B show illustrations of a Standing Shoulder Internal Rotation with Band exercise, in (A) starting and (B) later position.

FIGS. 19 A and B show illustrations of a Kegel Ball Squeeze exercise in (A) starting and (B) later position.

FIGS. 20 A and B show illustrations of an Adductor Squats exercise in (A) starting and (B) later position.

FIGS. 21A and B show illustrations of a Good Morning exercise in (A) starting and (B) later position.

FIGS. 22 A and B show illustrations of a Lunge Squat exercise in. (A) starting and (B) later position.

FIGS. 23 A and B show illustrations of a Nose-To-Wall exercise in (A) starting and (B) later position.

FIGS. 24 A and B show illustrations of a Calf Raises exercise in (A) starting and (B) later position.

FIGS. 25 A and B show illustrations of a Bird Dog/Quadruped exercise in (A) starting and (B) later position.

FIGS. 26 A and B show illustrations of a Side Plank exercise in (A) starting and (B) later position.

FIGS. 27 A, B and C show illustrations of a Pendulum exercise in (A) starting and (B) later position.

FIGS. 28 A and B show illustrations of a Side-Lying Horizontal Abduction exercise in (A) starting and (B) later position.

FIGS. 29 A, B, C, D, E and F show illustrations of a Toe Taps exercise in various positions.

FIGS. 30 A and B show illustrations of Wall Dips, Latissimus Dorsi activation exercise in (A) starting and (B) later position.

FIG. 31 shows an illustration of a prone plank exercise.

FIG. 32 shows an illustration of a pectoral muscle exercise.

FIGS. 33 A and B show illustrations of a bicep curls exercise in (A) starting and (B) later position.

FIGS. 34 A, B and C show illustrations of a latissimus dorsi exercise with a stability ball in (A) starting and (B), (C) later positions.

FIGS. 35 A and B show illustrations of a stability ball push-up exercise in (A) starting and (B) later position.

FIGS. 36 A and B show illustrations of a Twisting Lats exercise in (A) starting and (B) later position, with hand positions ((C), (D), (E)).

FIG. 37 shows a diagram of steps of the present method.

### DETAILED DESCRIPTION

Overall, the present invention focuses on evaluating the body musculature and, where appropriate, releasing muscles that are restricted and activating and exercising muscles that have become underutilized or latent. Preferably, the present method works on a subject's body for a variety of purposes. Overall, working with the body according to the present invention can provide a variety of benefits to a subject. The method may promote a subject's health and wellness and/or good body maintenance to a subject, improving for instance joint-muscle mobility, efficiency of movement by improving overall or local muscular physical durability, flexibility and/or mobility of the body, and providing balance to the body's musculature, through evaluation of individual muscles and local joints, and comparison of such with counterparts on the other side of the body. The method may be useful in reducing or minimizing a subject's tendency toward injury; i.e. injury prevention. The method may also be useful for the treatment of a joint or muscle-related injury or condition, for instance by minimizing the effects of the injury and reducing pain, as well as by removing restrictions that caused or exascerbated injury.

As mentioned above, when the body avoids using a restricted muscle and compensates with another, differences in muscle function and body type can affect the compensatory mechanism. For instance, athletes normally train to strengthen their “mover” muscles, and do not focus on stabilizer muscles. When a stabilizer muscle becomes restricted, they can often compensate for longer periods of time because their prime movers are so strong. However, their prime movers will ultimately become injured, leaving them unable to compete sometimes for months at a time. Also, many athletes maintain muscle contractions to achieve explosive movement, and do not land or decelerate with muscles in a lengthened position. The body absorbs force through motion. Bodies that are relaxed when struck with a blow will generally sustain less damage than those that are “tight”, contracted, not relaxed. Many athlete injuries occur as a result of restricted muscles and overall body imbalance. For office workers or others that sit, prolonged contraction and lengthening of different muscles can cause the body to compensate in ways that ultimately lead to injury or discomfort.

For athletes and nonathletes, forces are transmitted from one segment to another in the kinetic chain—a series of interconnected joints acting together to allow the body to move as it does. If there is a fascial/soft tissue restriction in a link along the chain, other joints have to absorb more force, and muscle activity has to compensate, and the result is a faulty kinetic chain. The body itself will start to compensate to overcome resulting restrictions in muscles.

For the purposes of the present invention, the following terms are to be understood as generally set forth below, and as discussed throughout the application:

“muscle” refers to skeletal muscle preferably having an origin on a bone and an insertion point on another bone, either directly or through a tendon. The term may refer to a single muscle or a group of muscles preferably in close physical proximity and/or contributing to the same or similar action. An example of a muscle according to the present invention may include for instance quadriceps, hamstrings, gluteus maximus, erector spinae. Where muscles work together, for instance like the psoas major, psoas minor, and iliacus muscles in the hip abduction test (together: iliopsoas), they may be considered as a muscle group for the purposes of the present invention.

Also for the purposes of this invention, a tendon attached to a muscle may be considered as part of the muscle. In particular, if a tendon appears to be restricted or related to a muscle that is restricted, then the tendon may be considered as part of the related muscle. In the alternative, a tendon may be considered as distinct from the muscle. For instance, when assessing a foot, assessment of tendons may be necessary in the present method. The focus of the present method is on restricted tissue, whether muscle or tendon.

“subject” refers to a human person.
“balance” and the like refers to an area of a body or an entire body that does not test as restricted, and preferably refers to a subject enjoying optimal and efficient muscle and joint interactions.
“imbalance” refers to areas that test as restricted and preferably to uneven local or regional muscle and joint interactions, such that muscles are not functioning with a proper length and tension, and joints are pulled away from their normal orientation.
“tester” refers to a person that performs a method of the present invention on a subject. The present invention may be performed by one tester, or more than one tester, during an evaluation or assessment of the present invention. A tester preferably understands muscle and joint physiology and anatomy, including knowledge of muscle origins and insertions, actions and antagonists, and understands how the kinetic chain works as a whole. A tester also preferably has experience in identifying local restrictions in muscles (for instance, a tight band or knot), and overall has good palpation skills. An important aspect of the present methods where appropriate is a tester's ability to determine whether tissue is restricted, whether restricted tissue includes localized restrictions, and ability to release such restrictions. Preferably, a tester is a physical therapist.
“trainer” refers to a person or object that trains a student to become a tester, and/or perform all or part, preferably all, of a method of the present invention on a subject. A trainer is preferably able to be or is a tester of the present invention. An trainer is preferably a physical therapist.
“restricted tissue” refers to soft tissue that presents as weak upon testing according to the present methods. Such tissue is preferably muscle, tendon or fascia. Typically, restricted tissue has local restriction(s) that may limit joint and muscle function. Without being bound by theory, for instance, a restricted muscle is typically a muscle that has contracted but then, upon ending the contraction, not fully relaxed to its proper resting length and tension.
“restriction” or “localized restriction” refers to a tight band of muscle or other tissue preferably identifiable by touch, preferably that feels resistant to palpation, for instance feeling like a hard nodule or knot upon palpation. Preferably, a restriction is an area of contracted or partially contracted muscle or tendon. However, the restriction may also be due to for instance scar tissue or other growths or matter that may restrict a muscle and/or tendon, or even other related tissue, such as fascia with scar tissue.
“compensating muscle” refers to a muscle used by the body in place of a restricted muscle, preferably to achieve a similar result to that which would be otherwise achieved by the restricted muscle. Use of the compensating muscle is usually less efficient than use of the restricted muscle.
“release” refers to removing a localized restriction in restricted tissue, preferably so that the area resistant to palpation no longer feels resistant by touch. Preferably, the localized restriction tissue is muscle that is overcontracted, so that release relates to relaxing the muscle to a proper resting length and tension. Localized restriction can also be, as discussed elsewhere herein, for instance restricted tendinous or even other related tissue such as fascia, restricted for instance by scar tissue. Preferably after release, the previously restricted tissue no longer presents as restricted when retested. Release is preferably achieved through manual pressure, preferably in combination with range of motion movement. A device may also be used to aid in achieving release. For smaller muscles, tendons in the foot and/or ankle, and so forth, manual pressure is similar to that applied for release of larger muscles, but more specific, over a smaller area, and with decreased manual pressure.
“quadriceps” refers to a muscle group having 4 major muscles: rectus femoris, vastus lateralis, vastus medialis obliquus, vastus intermedius.
“body” refers to the entirety of a living human being, including trunk, limbs, head, et al.
“Dorsiflexion” (DF) and the like represents a decrease in the angle between the dorsum (superior surface) of the foot and the shin, so that the toes are moved closer to the shin. Preferably, dorsiflexion is achieved by moving the ankle, and results in an angle of less than 90 degrees between the superior surface of the foot and the shin.
“Plantarflexion” (PE) and the like represents an increase in the angle between the dorsum (superior surface) of the foot and the shin. Preferably, plantarflexion is achieved by moving the ankle, and results in an angle of more than 90 degrees between the superior surface of the foot and the shin.

“maintain position”, “maintain the test position” and similar terms refer to a subject, having assumed a test position, resisting one or more attempts by a tester to move the subject from the test position. According to one preferred embodiment, if for instance a test involving a subject's leg is applied to a subject and the subject is able to overall stably resist the tester's attempt to move the leg and the subject is able hold the test position, then the subject “maintains position”. Where a subject maintains position according to methods of the present invention, the tested tissue is generally not considered restricted.

A subject is unable to maintain position when a tester is able to move the tested body part out of the test position. The tester's pressure is preferably firm pressure that takes into account the relative strength of the tester and the subject. The tester's actions are not based on the tester's strength, overpowering to the leg; however, the tester gives the subject's leg more than a gentle nudge. The steady pressure on, for instance, a subject's leg in proper test position, with pressure applied in the proper direction, will result in the leg slowly moving in the direction of force applied by the tester, with the subject unable to resist without recourse to other means of stabilization. If the subject is unable to resist the tester's movement, then the tissue being tested is considered as restricted. Without being bound by theory, it is believed the restriction in the tested tissue/muscle causes the muscle to be weakened, and while still functioning, unable to resist direct pressure when focused upon by a resisted test according to the present invention. Remarkably, an experienced tester may show a subject how his or her leg or other body part may be moved, by firm and steady pressure, with a simple push from the tester's hand or even one finger. The tester may need to apply pressure more than once to gauge reasonable pressure for testing that muscle, and to ensure the proper angle has been established for applying pressure.

During a test, if position is maintained on both sides of the body (e.g. each leg), then tests of each side (e.g. leg) may continue to assess the endurance of each, until one fails to maintain position while the other maintains position. Endurance testing is preferred in particular for athletes.

A subject's ability to maintain position is preferably categorized as “all or nothing”, in which the subject is either fully able to maintain position or fully unable to maintain position. Preferably, an assessment of muscle weakness is included when conducting a test of the present invention. Methods known in the art, such as manual muscle testing (MMT), may be used. A tester may for instance employ grading of muscle weakness or strength based on an MMT 5 point scale, and consider such when evaluating a subject. For instance 0—The subject demonstrates no palpable muscle contraction. (1) The subject's muscle contraction can be palpated, but there is no joint movement. (2−) The subject does not complete range of motion (ROM) in a gravity eliminated position. (2) The subject completes ROM with gravity eliminated. (2+) The subject is able to initiate movement against gravity. (3−) The subject does not complete the ROM against gravity, but does complete more than half of the range. (3) The subject completes ROM against gravity without manual resistance. (3+) The subject completes ROM against gravity with only minimal resistance. (4−) The subject completes ROM against gravity with minimal-moderate resistance. (4) The subject completes ROM against gravity with moderate resistance. (4+) The subject completes ROM against gravity with moderate-maximal resistance. (5) The subject completes ROM against gravity with maximal resistance.

A method of the present invention may be augmented by other standard physical therapy assessments, preferably taken before, during, and/or after administration of a test of the present invention. Information taken from these assessments may be useful in assessing overall imbalance in the body, and in identifying potentially restricted muscles. For instance, bony landmarks relating to pelvis alignment and stability, ilium heights, ASIS (anterior superior iliac spine) height and PSIS (posterior superior iliac spine) height, PSIS rotation, Gillett test, and Adams test may augment the present method, with the body in standing, supine, and/or prone position. Gait assessment may be useful and include for instance symmetry, foot strike, stride length and/or toe off analysis. Pelvic imbalances may be considered in view of supine baseline measurements (e.g. internal rotation (IR), external rotation (ER), range of motion (ROM), hamstring flexibility, hip flexor flexibility, special tests, ASIS mobility, neurological testing. A standing-up test may include a standard alignment test, where a person's pelvic bone placement is considered. If one side is higher than the other, the difference may be due to tightness on the higher side, indicating imbalance on that side of the body. Assessments of joint angle at slow velocity passive stretch (also known as R2 assessments) may also be taken. Pelvic imbalances may also be considered in view of prone baseline measurements (manual muscle testing (MMT), flexibility, special tests, sacral nutation, SI (sacroiliac) joint mobility, neurological testing). Assessments of joint angle at fast velocity passive stretch (also known as R1 assessments) may also be taken. As a general rule, cramping may indicate restrictions where the cramping occurred. The subject's quality of movement in achieving a test position may also be considered.

The below tests are designed to evaluate one or more muscles or muscle groups. Taken together, the tests allow for the evaluation of the subject's body overall, and potential imbalance therein. Most tests of the present invention are “resisted” tests, in that once a test position is assumed by the subject, the subject attempts to maintain the position by resisting a tester's efforts to move the subject from the test position. Tests on the foot and ankle are optional and due to their more delicate physiology based on manipulation more than resistance from the subject. Testing preferably begins with specific tests of the lower body, to stabilize the pelvic region, and then preferably proceeds to the upper body, to stabilize the scapular region. Testing according to the present invention is dynamic, in that a test showing restricted tissue will preferably be followed by release of the tissue and then a repeat of the same test, to determine whether the tissue is still restricted, and again subsequent release, until the tissue no longer presents as restricted or is identified as having a true weakness, as discussed below.

A test according to the present invention is preferably bilateral, with the strength of a muscle on one side of the body (e.g. quadriceps) considered not only in itself, but also in comparison with a counterpart muscle on the other side of the body. For instance, a test of the present invention may test first the right arm biceps and then the left arm biceps; first the left hamstring and then the right hamstring muscle; and so forth. The order of testing may be e.g. right side to left side or left side to right side. Preferably in any test, when comparing results between two counterpart muscles or muscle groups, if one side presents as weaker than the other side, or as having less endurance than the other side, then the side presenting as weak or having less endurance is considered restricted and checked for local muscle restrictions. This is particularly true for athletes, as athletes may compensate for weakness with other muscles better than non-athletes. Preferably, the tester estimates a subject's likely level of strength, and thus the level at which a subject may reasonably maintain position with an unrestricted muscle, when performing a test and considering the subject's ability to maintain position and perhaps identifying a muscle as potentially restricted.

Testing alone has its benefits, according to the present invention. The tests identify the presence or absence of restricted tissue, providing information regarding potentially weakened muscles that may be useful to the subject or tester. Preferably, tests of the present invention are used in conjunction with other steps as discussed herein.

Lower Body Tests 1-4 are necessary for evaluating the lower body according to the present invention. Lower Body Test 5 is preferred for the present method, and necessary for a subject having a foot or ankle injury. Lower Body Tests 6-8 are optional, and necessary for a subject having a foot or ankle injury. As a general rule, when a Test comprises different subtests, the subtests may be performed in any order. Also as a general rule, tests are performed in a single plane of motion, with pressure applied by a tester in only one direction. Solid lines indicate initial test position. Broken lines indicate failure to maintain position.

### Lower Body Test 1: Supine Bilateral Hip Abduction Test

The primary muscles tested with this test are the psoas and iliacus muscles. The purpose of the test is to determine whether a person is able to stably hold resisted hip abduction.

The test is performed with the subject lying supine (flat on back), preferably on a stable flat table, with hard padding (not soft with give). As shown in FIG. 1 (solid lines), the subject assumes a test position in which the subject's legs are positioned flat on the table about shoulder width apart, feet and ankles in a resting, neutral position (not in dorsiflexion or plantarflexion or rotated). The subject is instructed to resist adductive pressure applied by the tester to move the subject from the test position, to maintain the test position if possible. The tester grips or otherwise makes contact with one or both of the subject's legs (both, in the Figure) preferably to the outside of the leg and slightly above the ankle and then applies pressure and attempts to push the leg(s) inward, toward the center line of the body. The subject's legs do not leave the table, as the test (like other tests of the invention) is performed within only one general plane of movement and one general direction of force. During the test, the subject's arms are at rest at the subject's side. The subject may not grip anything, including the side of the table or other object, or even part of the subject's own body, during the test, as such gripping may interfere in the determination of whether the subject's body and in particular iliopsoas muscle group can stabilize sufficiently without such assistance. Similarly, the subject may not tuck his hands beneath his body or otherwise use hands to stabilize himself during the test. This is generally true for all tests. The tester may apply pressure in varying amounts, for instance from minimal to moderate to a maximum amount reasonable for a given subject, so as to not cause harm. The tester may apply pressure just once on each leg, or several times (for instance 1-15, preferably 1-5), in a row or alternating with testing on the other leg. Preferably, pressure is applied to each leg the same or a similar number of times. Both legs should be tested and ability to maintain position considered for each leg, preferably alone and in comparison with the other.

The subject's ability to maintain the test position is then considered. A complete failure to maintain position is shown by a broken line in FIG. 1. Different measures of such ability include, but are not limited to, those described above. As with other tests, if the subject is able to maintain each leg's position, then the test is preferably performed several times on each leg for endurance, until one leg is unable to maintain position as long as the other. Endurance tests are particularly preferable in athletes, as overdeveloped muscles in an adjacent area may for a time compensate for an inability to maintain position by the muscles under scrutiny.

If the subject is able to maintain position for one leg but not the other, after performing the test once or more or for instance as in endurance testing, then the iliacus muscle on the side that could not maintain position is identified as restricted. The restrictions may be identified through palpation at this time, or for instance after completion of step 2 below. The weaker leg is identified as possibly restricted, and palpated for local restriction.

If the subject is not able to maintain position with either leg (both legs fall in), then the psoas is identified as restricted according to the present method, with localized restriction particularly likely on the side of the “upslip”/elevation. Information from an initial or other assessment may be particularly useful here (i.e. elevation in ASIS, AP movement or lack thereof, where lack of AP movement indicates soft tissue restriction and pain). Also, the range of motion in the joint may be considered, and either palpation of the iliopsoas muscles attended to at this time or for instance after completing test 2 or tests 2 and 3, below.

### Lower Body Test 2: Supine Straight Leg Raise Test

The quadriceps (particularly rectus femoris) and iliacus are the primary muscles tested with this test, along with the adductors, TFL, sartorius and psoas muscles. The test is performed to determine whether the subject can stably maintain a straight leg raise (hip flexion), resisting downward pressure on the leg.

The test is performed with the subject lying supine (flat on back), preferably on a stable flat table, with hard padding (not soft with give). As shown in FIG. 2, the subject assumes a test position in which the subject's legs are positioned so one leg is raised in the air above the body, preferably forming an angle of about 45-80 degrees between the bottom surface of the leg and the table surface, and the other leg is flat on the table (or if necessary, as close to flat as is comfortable for the subject). This test is to be conducted with the foot in dorsiflex (DF; toes up) or plantar flex (PF; toes pointed) position, and the leg in neutral (kneecap facing the ceiling), external rotation (ER; kneecap away from the body), or internal rotation (IR; kneecap toward the body) positions. Overall when performing this test, the tester will preferably test the subject in all of the following six positions (preferably in the following order, but not necessarily), performing six subtests: DF-neutral; DF-IR; DF-ER; PF-neutral; PF-IR; PF-ER. Each subtest is conducted independently on each leg, preferably with that leg remaining raised throughout all six subtests. These 6 subtests may be performed in any order. The subject is instructed to resist downward pressure applied to the raised leg, in which the tester grips the subject's raised leg preferably slightly above the ankle and attempts to push the leg toward the table. During the test, the subject's arms are at rest preferably on the table at the subject's side. As with all tests of the present invention, the subject may not grip the side of the table or other object including part of the subject's own body, as such may stabilize the subject's body and disrupt the test. Also, muscles may be palpated and restrictions identified and released. However preferably, further or all subtests of this test are run before the palpation step begins.

When the subject's foot is dorsiflexed and the subject's knee is neutral (faces the ceiling), then if it is determined the subject is not able to maintain the raised leg test position for one or both legs, the iliacus muscle and proximal quadriceps (particularly the rectus femoris) are identified as restricted.

When the subject's foot is dorsiflexed and leg externally rotated, if one or both legs is unable to maintain position, the adductor muscles are identified as restricted.

When the subject's foot is dorsiflexed and leg internally rotated, if one or both legs is unable to maintain position, the TFL and proximal vastus lateralis (of the quadriceps) are identified as restricted.

When the subject's foot is plantar flexed and the subject's leg/ankle is neutral, then if it is determined the subject is not able to maintain the raised leg test position for one or both legs, the quadriceps (particularly the vastus intermedius) are identified as restricted.

When the subject's foot is plantar flexed and leg/ankle externally rotated, if one or both legs is unable to maintain position, the quadriceps (particularly vastus medialis and vastus medialus oblique) are identified as restricted.

When the subject's foot is plantar flexed and leg/ankle internally rotated, if one or both legs is unable to maintain position, the quadriceps (particularly distal lateral quadriceps, or vastus lateralis) are identified as restricted.

If the subject is not able to maintain leg position throughout all 6 subtests of this test, the subject's pelvis may not be stabilized. The tester preferably will return to test 1 above and release restrictions in the iliopsoas muscle accordingly.

For this particular position, even if the subject is able to maintain position, palpation of the above muscles is preferred, as subjects may presently strongly in this position and falsely indicate strength therein. Also preferably, the tester will consider the range of motion available for internal rotation of the hip, and check for restrictions in the above-mentioned muscles if range of motion appears to be lacking.

### Lower Body Test 3: Prone Straight Leg Raise Test

The rectus femoris and quadriceps are primarily tested with this test. This test is performed to determine whether the subject can stably extend the hip, resisting downward pressure on the leg. This test is to be conducted with the foot in dorsiflex and plantar flex positions, and the leg in neutral (kneecap facing the ceiling), external rotation, and internal rotation positions. As with the above tests, the quality of movement and subject's ability to hold position, preferably throughout all 6 subtests, are key to this test. Initial evaluations of PSIS levels, sacral nutation, and mobility of each sacroilial joint are preferably available to the tester. Also, an evaluation of the hip joint is preferred, including noting where the extension is coming from (e.g. considering whether there is movement in spine; or sacroilial joint) and quality of motion (e.g smooth vs. painful).

As shown in FIG. 3, the subject assumes a test position in which the subject is lying prone (flat on belly), preferably on a stable flat table, with hard padding (not soft with give). The subject's legs are positioned about shoulder width apart and one hip is flexed by raising one leg in the air above the table, preferably forming an angle of about 20 to about 45 degrees between the table surface and the nearest surface of the raised leg. The subject's other leg is flat on the table, knee facing downward into the table. The subject is instructed to resist downward pressure applied to each leg during each subtest, in which the tester grips the subject's leg preferably slightly above the ankle and attempts to push the leg toward the table. During the test, the subject may not grip the side of the table or other object. Preferably, pressure is applied first to one leg, and then to the other, and preferably all 6 subtests performed without lowering the given leg. These 6 subtests may be performed in any order. Preferably, the tester notices the quality of movement of the subject's hip extension, and in particular where the movement originates, and whether there is movement of the pelvis and sacrum. In the Figure, solid lines indicate the test position (subtest: neutral leg, plantarflexion), and the broken line indicates a failure to maintain position by the subject.

Neutral leg position/Dorsiflexion

Where on the subject's raised leg the foot is dorsiflexed (toes straight not curled), knee facing downward (no rotation to foot/ankle/leg), if a subject is unable to main this test position for either leg, then the lumbar paraspinals and/or quadratus lumborum are identified as restricted. If the lumbar paraspinals and/or quadratus lumborum muscles are palpated and restrictions located and released, and the leg is tested and falls again, then a restriction is identified as present in the gluteus maximus. If one or more restrictions in the gluteus maximus is found, the muscles released, and the leg falls again, then the tester should assess the sacroilial joint (specifically, the sacroiliac ligaments). The fascia and ligaments may be released according to the present invention, if localized restrictions are found.

### External Rotation, Dorsiflexion

In this test, the subject's toes are externally rotated, foot is dorsiflexed. If the leg falls, then a restriction is identified in the gluteus medius and/or minimus.

### Internal Rotation, Dorsiflexion

In this test, the subject's toes are internally rotated, foot is dorsiflexed. If the leg falls, then a restriction is identified in one or more of the adductor muscles and/or the hamstring muscle.

### Neutral/Straight Toes, Plantarflexion

If the leg falls right away, then a restriction is identified as in the distal hamstring.

If one or more restrictions in the distal hamstring is found, the restriction(s) released, and the leg is tested and falls again, then a restriction is identified as present in the distal bicep femoris and/or posterior knee, specifically origin of the gastrocnemius.

If one or more restrictions in the distal bicep femoris and/or posterior knee is found, the muscle(s) released, and the leg is tested and falls again, then a restriction is identified as present in the gastrocnemius muscle.

### External Rotation, Plantaflexion

If the leg falls right away, or presents as weak, then a restriction is identified as in the distal lateral hamstring muscle(s).

If one or more restrictions in the distal lateral hamstring muscle(s) is found, the restriction(s) released, and the leg is tested and falls again, or presents as weak, then a restriction is identified as present in the iliotibial band (ITB).

If one or more restrictions in the iliotibial band is found, the muscle(s) released, and the leg is tested and falls again, then a restriction is identified as present in the proximal lateral gastrocnemius muscle.

### Internal Rotation, Plantarflexion

If the leg falls right away, or presents as weak, then a restriction is identified as in the distal medial hamstring muscle(s).

If one or more restrictions in the distal medial hamstring muscle(s) is found, the restriction(s) released, and the leg is tested and falls again, or presents as weak, then a restriction is identified as present in the distal medial hamstring tendon.

If one or more restrictions in the distal medial hamstring tendon is found, the muscle(s) released, and the leg is tested and falls again, then a restriction is identified as present in the pes anserine.

### Lower Body Test 4: Side-Lying Leg Raise Tests

This test identifies restrictions through hip abduction and adduction. The primary muscles tested are the gluteus medius and/or minimus muscles (top leg), and hip adductor muscles (bottom leg). For this test, the subject lies on one side preferably on a lightly padded table. As shown in FIG. 4, the subject assumes a test position in which the subject's legs are straight and stacked; one arm preferably rests along the top of the subject's body, and the other arm preferably rests comfortably along and under the subject's body. As with other tests of this invention, the subject is asked to not grip the table or anything else, to avoid interference with test results. To assume the position for the side-lying leg abduction test, the subject raises the upper leg into the air, keeping the leg straight, in abductive position, with the lower leg remaining on the table. The test position may include both DF and PF. The tester applies pressure on the top-most surface of the raised upper leg, preferably below the knee and above the ankle, more preferably about mid-calf, and attempts to move the subject's upper leg from position and toward the table surface.

If the subject is unable to maintain position with the upper leg, the gluteus medius and/or minimus is identified as restricted. As this was already checked and released when performing the previous test (Lower Body Test 3: Prone Straight Leg Test, external rotation, dorsiflexion), strength tests are performed in this regard.

Next, the Side-Lying Leg Adduction test is performed on the lower leg. The test position is as shown in FIG. 4, but the upper leg is preferably supported by the tester throughout this test. The subject is instructed to hold position and the tester then applies pressure preferably above the ankle of the lower leg, attempting to move the lower leg back to the table.

If the subject is unable to maintain position with the lower leg, the hip adductor is identified as restricted. The use of the Ober's test position may be used to stretch these muscles, if needed.

### Lower Body Test 5: Knee Flexion Test

This test identifies restrictions through knee flexion. The primary muscles tested are the gastrocnerneus and/or soleus muscles. For this test, as shown in FIG. 5, the subject assumes a test position in which the subject lies prone on a flat padded table, with legs and knees face down and ankles and feet at rest (no rotation). Asking the subject to bend one leg at the knee and keep the leg from hip to knee on the table, the tester raises the lower part of the leg to approximately a right angle with the table, and instructs the subject to resist pressure from the tester, to press the lower part of the leg back to the table.

If the leg falls, or presents as weak, then a restriction is identified as likely in the soleus muscle, and possibly the gastrocnemeus muscle. The tester also, preferably, assesses lumbar vertebra alignment and mobility at this stage of testing. The test may be performed on top leg first, then bottom leg; or bottom leg first, then top leg.

Lower Body—Ankle and Foot Tests

Mobility assessments of the mid-foot (including pronation and supination), fore-foot, calcaneous (including lateral or medial tilt of the calcaneous), each metatarsal including preferably the fifth metatarsal, and the talo-crural region are preferably assessed prior to or concurrent with the below tests. Restrictions located in restricted tissues may be released and latent muscles activated and exercised for foot and ankle muscles and tendons as indicated for instance above.

As a general rule, foot and ankle testing is different from upper body and other lower body tests in that foot and ankle testing is only for joint mobility, not for strength. Subjects do not assume test positions and attempt to maintain position. Rather, a tester identifies restrictions in movement both in terms of whole movement such as whole foot movement and individual joint movement. As in the above tests, release of localized restrictions is guided by soft tissue identified as restricted (preferably tendinous tissue), and performed generally as described for foot/ankle release below.

### Lower Body Test 6: Ankle Test

With subject in a sitting position, feet unsupported, the tester preferably considers calcaneal movement, in particular in view of the stability of the tibia and fibula, in part by flexing, extending the foot and rotating the ankle. Identification of an anterior or inferior positional fault is preferred, if present.

A lateral tilt (e.g. sprain, or remnant thereof) in the ankle indicates a restriction in the lateral malleolear retinaculum and related muscles. See FIG. 6C.

A medial tilt in the ankle indicates a restriction in the medial malleolear retinaculum and related muscles. See FIG. 6B.

### Lower Body Test 7: Mid-Foot Test

With subject in a sitting position, feet unsupported, the tester checks for foot eversion and inversion. See FIGS. 7A and 7B, respectively. Weakness in eversion and inversion points are tested according to tests known in the field.

Foot inversion and/or a weakness in inversion points indicates a restriction in the adductor and hip stabilizer muscles. Foot eversion and/or a weakness in eversion points indicates a restriction around the 5^{th} metatarsal/lateral border and/or anterior talocrural joints and/or arch.

### Lower Body Test 8: Fore-Foot Test:

The tester considers eversion and inversion points, preferably identified during examination of the mid-foot during the mid-foot test indicated above. The mobility of the metatarsals is also considered. Forefoot eversion or inversion indicates restrictions may be present in the plantar fascia and fibularis longus (also known as the peroneus longus) muscle, and other related muscles.

### Upper Body Tests

The goal for upper body tests is to put the scapula in its optimal position. The following tests are necessary, in the indicated order, to achieve this goal, unless indicated otherwise.

### Pre-Tests

Initial assessments of the upper body may be helpful when preparing an evaluation according to the present invention. Such assessments preferably include one or more of baseline measurements for the subject, seated and supine, for range of motion, strength, special tests, neurological testing, and palpation for muscle restrictions for instance in areas of tenderness. Also, for the supine subject, vertebral mobility, Passive Physiological Intervertebral Movement (PPIVM) may be assessed.

Upper Body Tests 1, 2, 4 and 5 are necessary for evaluating the upper body according to the present invention. The remaining tests are preferred. As with the Lower Body Tests, tests must be performed in the listed order.

### Upper Body Test 1: Supine Shoulder Adduction Test

This test is to assess the stability of the scapula and its attached muscles. The subscapularis muscle is the primary muscle tested by this test. As shown in FIG. 9, the subject assumes a test position in which the subject lies supine preferably on a lightly padded table as indicated for other tests, body at rest, arms resting at the side of the body on the table, without gripping hands or otherwise stabilizing the body throughout the test. For each arm, the tester instructs the subject to keep the arm straight. The subject is then instructed to resist horizontal movement of the arm away from the body. The tester grips the arm, preferably between elbow and wrist, and applies steady pressure in a firm attempt to move the arm away from the body, remaining still on the same plane as the table. Preferably, the tester also considers whether the subject can keep the arm straight when pressure is applied, and confirms the arm is straight throughout the test.

If the subject is unable to maintain position, then the subscapularis muscle is identified as restricted. Palpation of the subscapularis is performed. Preferably during this test, palpation of upper trapezius and levator muscles, and preferably also of the anterior deltoid and pectoral muscles, and of the bicep, may be performed, to locate muscle restrictions. Most preferably, such palpations are performed in the following order, however, some or all of the muscles may be palpated for instance at approximately the time that palpation of the subscapularis muscle is performed.

If one or more restrictions in subscapularis muscle is found, and the restriction(s) released, and the arm is tested and fails to hold position again, then a restriction is identified as present in the pectoral and/or bicep muscles of the arm.

If one or more restrictions in the pectoral and/or bicep muscles is found, the muscle(s) released, and the arm is tested and fails to hold position again, then a restriction is identified as present in the diaphragm.

### Upper Body Test 2: Supine Horizontal Shoulder Adduction Test

This test is also important in assessing scapular stability. As shown in FIG. 10, the subject assumes a test position in which the subject lies supine preferably on a lightly padded table, body at rest, arms resting at the side of the body on the table, without gripping the table or otherwise stabilizing the body throughout the test. One arm is raised straight up in the air, approximately perpendicular to the body. The subject is instructed to maintain position and resist the tester's attempt to move the arm back to the body. The tester then grips the arm, preferably between elbow and wrist, and applies steady pressure in a firm attempt to move the arm back to the table. Preferably, the tester also considers whether the subject can hold position without rotating the body.

If the subject is unable to maintain the test position, then the pectoral muscle is identified as restricted.

### Upper Body Test 3: Supine Elbow Flexion Test

This test is also useful in assessing scapular stability, and its use is preferred, although it is required in the method of the present invention only where the subject presents with an elbow injury. Otherwise, its use is preferred in the order indicated in the present invention. The primary muscle tested is the biceps. As shown in FIG. 11, the subject assumes a test position in which the subject lies supine preferably on a lightly padded table, body at rest, one arm resting at the side of the body on the table, without gripping hands or otherwise stabilizing the body throughout the test. The other arm is flexed at the elbow, such that the upper portion of the arm, shoulder through elbow, are flat on the table and parallel to the trunk of the body, and the lower portion of the arm, elbow through wrist, is flexed at preferably an approximate 90 degree angle perpendicular to the body. The subject is instructed to maintain the flexion and resist pressure to place the lower portion of the arm back on the table. The tester then grips the arm, preferably between elbow and wrist, and applies steady pressure in a firm attempt to move the lower arm and hand toward the table. Preferably, the tester also considers whether the subject's body shifts while resisting.

If the subject is unable to maintain position, then the bicep muscle is identified as restricted.

### Upper Body Test 4: Side Lying Shoulder Abduction Test (Range of Motion)

As shown in FIG. 12, the subject assumes a test position in which the subject is lying on one side, top arm at rest on the side of the body. The subject is instructed to try to maintain position. The tester places hands on the under side of the subject's top arm, preferably between elbow and wrist and more preferably nearer the subject's wrist, and attempts to move the arm away from the body in a plane approximately perpendicular to the table.

If the subject is unable to maintain position, then the insertion of the latissiumus dorsii—the teres major and teres minro—is identified as restricted.

### Upper Body Tests 5 and 6: Prone Shoulder Horizontal Abduction and Prone Elbow Extension Tests

In addition or in keeping with those initial assessments generally indicated above, initial assessments in this position may include vertebral mobility measurements, passive PA, central PA, unilateral PA and transverse PA. Rib position and fascial mobility are preferably considered. Also, initial assessments may include manual muscle testing of postural muscles, preferably including assessment of one or more of the lower trapezius, mid trapezius and rhomboid (shoulder horizontal abduction testing). Also, palpation may aid the tester in determining obvious muscle restriction, considering rib mobility, and other noticeable characteristics of the subject's body.

These prone tests are also important in assessing scapular stability. The Prone Shoulder Horizontal Abduction Test (Upper Body Test 5) is required in the present method; the Prone Elbow Extension Test (Upper Body Test 6) is preferred but optional in the present invention. As shown in FIG. 13, the subject assumes a test position in which the subject lies prone preferably on a lightly padded table, body at rest, both arms resting at the side of the body on the table, without gripping hands or otherwise stabilizing the body throughout the test. One arm is moved away from the body as shown, into a half “T” position, palm facing the floor. The subject is instructed to keep the arm straight and raise his shoulder and arm off of the table, and then maintain position. The tester then grips the arm, preferably between elbow and wrist, and applies steady pressure in a firm attempt to move the arm straight down, toward the table and floor.

The prone elbow extension test position is shown in FIG. 14, where one arm of the subject is moved approximately as shown, bent at the elbow, and the subject is instructed to maintain position while the tester grips the arm preferably between wrist and elbow and applies upward pressure. The Figure is intended to indicate the tester's hand on the far side of the subject's arm. Preferably, the tester also considers the quality of movement of each arm, and in particular whether the subject's body rotates with resisted movement. Each test is preferably performed on each arm.

If the subject is unable to maintain position for the Prone Horizontal Shoulder Abduction Range of Motion Test, then the rhomboid and/or mid-trapezius muscle(s) is identified as restricted.

If the subject is unable to maintain position for the Prone Elbow Extension Test, then the lateral triceps is identified as restricted.

### Upper Body Test 7: Shoulder Flexion Test

The goal of this test is to assess deltoid strength and scapular mobility. While not required, the test is preferably performed with an upper body assessment.

As shown in FIG. 15, the subject assumes a test position in which the subject is seated with arms at rest at the subject's side. The tester instructs the subject to straighten at least one arm in front of the body, preferably at about a 90 degree angle, and to maintain such position. The tester then grips or otherwise contacts the subject's arms between wrist and elbow, preferably in the forearm nearer the wrist, and exerts downward pressure to move the arm bark toward the body. The test is to be performed on each arm. Also, or in the alternative, the test may be performed with at least one arm raised to the side of the body instead of the front.

If the subject is unable to maintain position for any of these tests, then the scalenes and possibly the anterior deltoid (likely near origin) are identified as restricted.

At this point in the evaluation, optional thoracic tests may be useful (not shown). The tests include the subject remaining seated up right as in FIG. 15, but placing both hands behind the head, fingers interlocked, elbows out, and then performing side bends, front/back hinge bends, and then moving arms to hug himself the subject is to perform twisting motions, all to consider thoracic mobility.

### Upper Body Test 8: Abdominal Test

The goal of this test is to assess the abdominal area. The primary muscles tested are muscles of the diaphragm and the oblique muscles. The test is optional in the context of the present invention. The subject lies flat on his back, legs and arms completely straight and at rest. The tester instructs the subject to perform deep diaphragmatic breathing, with the subject breathing in and out through his mouth, blowing out like candles with pursed lips. See FIG. 16, showing a subject on his back (solid lines) and deep breathing (broken lines). This test is not a resisted test. Rather, the tester observes the subject's breathing, considers how the rib cage moves, whether upper or lower chest is most affected with breathing, and investigates potential restrictions in the soleus, iliacus, insertions of abdominal muscles/obliques and the diaphragm itself. As mentioned elsewhere herein, the tester is a person of skill in the art, who knows muscle locations and other relevant anatomy.

For all of the above tests, training and course materials according to the present invention comprise training on helping a subject achieve a test position, on instructing the subject to resist pressure aimed at moving the subject out of test position, on properly applying said pressure and attempting to move the subject out of test position, and on determining whether the subject stably maintained position or was unable to maintain test position. Such training also comprises instructing a proper test position so that a subject cannot stabilize himself with other parts of the body during a test, negating the purpose of the test.

### Palpating Step

Upon identifying restricted tissue (preferably muscle tissue), the restricted tissue is palpated to search for one or more localized restrictions. Palpation refers to examination by a series of touches or strokes along the restricted muscle or tissue, preferably in deep tissue style. As indicated above, a localized restriction is a tight band of muscle or other tissue that feels resistant to palpation, for instance feeling stiff or hard or like a hard nodule or knot upon palpation. Typically (and preferably) in the upper body and lower body restrictions are found in muscle and fascia, however in particular in the foot and ankle, restrictions may be present in muscle and/or other tissue such as plantar fascia and/or tendon(s) (in particular, dorsum of the foot and plantar surface of the foot).

The ability to search for and find the exact location of localized restrictions is essential to this step. While a skilled person may be able to guess approximately where a localized restriction is, the precise location of the restriction must be located for proper release. Performance of this step preferably includes training in anatomy and physiology and experience in palpating tissue to find localized restrictions.

Training and course materials according to the present invention comprise training on how to feel for localized restrictions and preferably on what it feels like to be restricted.

### Release Step

Release of restrictions according to the present invention uses manual pressure, preferably combined with active range of motion, to help break up restrictions including scar tissue within restricted tissue. Manual pressure may be achieved through a tester's body alone, for instance with fingers or forearms applying pressure to, massaging and otherwise relaxing or breaking up a localized restriction. Also, a tool such as a massage tool may be used to help break up, relax and ultimately release a restriction.

Active range of motion movements in particular may increase blood flow to a restricted area, which helps relax the muscle. Movements are preferably parallel and perpendicular to the pressure applied. The movement of the muscle also improves the length of the muscle; other restricted tissues also benefit from such movement. Release of restrictions preferably activates a stretch reflex—a natural contraction of muscle in response to stretching, to regulate muscle length—which helps restore muscle function in a subject in a shorter time due at least in part to eccentric activation. Stretching a muscle after release is also preferred in the present invention. Exemplary stretching exercises are described in the copending US provisional application “ACTIVATION AND/OR TARGETED EXERCISES”, and are expressly incorporated by referenced herein for this purpose.

After release, the test that identified restricted tissue is preferably performed again, to determine whether the ability to maintain position improves, or whether position cannot be maintained even after all palpable restrictions have been removed. Release of localized restrictions according to the present invention is transformative, in that the muscle is changed by release. Restoration of strength is determined thereafter by reassessment.

From a training and educational course perspective, training may include discussions of muscle proprioceptors and physical mechanisms relating to muscle stretching. Without being bound by theory, it is believed that upon release the muscle lengthens, causing the muscle spindle to stretch, which in turn increases sensory fiber activity as the fibers detect the velocity of the stretch, which increases alpha MN activity. The muscle then contracts and muscle length decreases to resist the stretch. This reflex is a protective mechanism that tries to regulate muscle length and ensure it stays constant. Also, upon release, force is transmitted through the Golgi tendon organ (GTO), which detects the increase in muscle force and may determine too much muscle force has been generated. The GTO then stimulates an inhibitory interneuron to reduce the activity of MNs, decreasing muscle contraction and force. This reflex ensures force is constant within the muscle. Overall, without being bound by theory, it is believe that releasing a tight muscle will activate a latent muscle. Once that latent muscle is stimulated, strength and endurance need to be built in order to keep the muscle active and in use for the long term. Activating a latent muscle allows for more overall force generation. If 50% of muscles are being used, activating an extra 10% of muscles will make the body that much more efficient. Also, training may include reference that postural changes lead to instability of joints, which requires other muscles to increase their activation, and that when movers try to become stabilizers, our body becomes inefficient. When stabilizers become stronger, movers are allowed to be prime movers and become more efficient. This is evident in the athletic population because athletes normally train to strengthen and not stabilize, and so can normally compensate for restricted tissue for longer periods of time. However, eventually they will no longer be able to compensate, and then can be injured. This information and other is provided elsewhere in this application as well.

### Activation and Targeted Exercise Step

The order of testing is essential to the present invention. While during an evaluation several steps may be performed at one time, and restrictions identified and released in convenient sequence, overall the steps as listed herein must be performed in the order listed, with all restrictions removed, in order to avoid false readings and identify any true weakness in the muscles. If taken out of order, restrictions in one area of the body may interfere with tests in another, resulting in the readings that will not necessarily correctly identify restricted tissue and thereafter, muscles having a true weakness, and related latent muscle(s). This is discussed more thoroughly below.

After all tests have been conducted and restrictions released, and tests performed again as needed and in their proper order, a true weakness exists where tissue still presents as restricted, but no localized restrictions may be found. Typically the true weakness is a muscle that has grown weak over a substantial period of time of underuse. Without being bound by theory, the muscle became sufficiently restricted at an earlier point for the body to avoid and even ignore the muscle, using other muscles to compensate for the weak muscle's inefficiency. That muscle now becomes the focus of activation and targeted exercise, to make the muscle stronger and train the body to again use that muscle efficiently.

Preferably, releasing tight muscle(s) and/or other restricted tissue, and in particular activating a muscle having a true weakness, will show a second, latent muscle in the same region or another region, used less efficiently by the body because of the restricted tissue/true weakness. The second, latent muscle may be an antagonist to the first (restricted) muscle. For instance, if the left leg adductor muscles are restricted, the left leg abductor muscles may be latent and in need of activation. Preferably, the latent muscle is activated and exercised as well. Activation preferably occurs at the time the true weakness or second latent muscle is identified, with a tester present to preferably further palpate and exercise the muscle, and instruct the subject in the proper targeted exercise for continued at-home exercise. Activation always includes exercise of the muscle, and may include for instance further palpation. Targeted exercises occur after muscle activation, whether immediately or over for instance several days, weeks, or months. As time passes, preferably the subject will find the exercises to be easier to conduct, and more efficient, showing the body has begun to use the targeted muscles more efficiently.

Once the latent muscle is stimulated via release of the muscle identified as having a true weakness, strength and endurance may need to be built in the second latent muscle to keep the muscle active and able to perform its intended function. Activation and targeted exercise for latent muscles may also be conducted. Activation and exercise of such underused muscles will eventually make the subject stronger and more efficient, as the increase in useful muscle will allow for instance for more overall force generation. For instance, if 50% of muscles are being used, activating an extra 10% of muscles will make the body that much more efficient.

Overall, muscle activation exercises are geared to “turn on” specific muscles after restrictions have been released, to help the muscles gain or regain their most proper function, and contribute to overall balance of the body. Activation is followed by strengthening exercises, preferably with stretching/lengthening occurring at the end. The goal is to be able to perform muscle activation exercises with greater and greater velocity. Stretching alone will not activate a muscle.

Muscle activation focuses on restoring the latent muscle's ability to contract. If there is overuse, the muscle spindle's sensitivity will be reduced, and the muscle won't be as able to regulate force in relation to stretch or load. When a muscle doesn't have proper neurological input, it can't perform efficiently.

Activation of the latent muscle is preferably achieved by lengthening the muscle. Preferably, the latent muscle is first exercised via eccentric loading and activity. If the muscle is not activated, then concentric activity should be used to activate and exercise the muscle.

Activation is a transformative process. Activation of a muscle experiencing true weakness, or latency, may affect different subjects differently. Subjects sometimes refer to an activated muscle as feeling “light”, or may describe the activated muscle as experiencing a tingling or cascading sensation, sometimes for hours after ending an evaluation according to the present invention. Also, an activated muscle may feel a soreness, such as that associated with substantial exercise, for hours or even days after activation. Some subjects, in particular athletes, comment that the activated muscle burns upon activation and for some time thereafter. Without being bound by theory, it is believed that release of restrictions increases blood flow to the tissue, and increases nerve conduction therein. The restrictions may be viewed as working like a tourniquet. Once released, the rush of blood and nerve activity results in sensations such as described above.

The activated muscle is preferably exercised to restore normal function to the activated muscle itself, as well as related and surrounding muscles and tissues, and the entire body overall. Activation is based on the entire kinetic chain of the body. A true weakness cannot be corrected by removing restrictions. The muscle has not been functioning optimally, and has unbalanced others. Activation and then exercise is necessary to strengthen the muscle and reintroduce it into the kinetic chain.

While released muscles may be activated, the true weakness of the e.g. upper and/or lower body is always a second muscle, different from a released muscle. The second muscle can be in a surrounding area, or can be distance from the released muscles. Can release more than 1 muscle to find underperforming muscle. Through the release of a first muscle(s), the second muscle will also function better.

Several methods are known for exercising specific muscles, once it is known they should be isolated and exercised. For instance, devices for exercising abdominal muscles or lower back muscles are well known. Activation/exercises for muscles that show a true weakness are shown for instance in FIGS. 19-29. A full lower and/or upper body analysis will help with the identification of exercises that should be used.

A true weakness may reside in one or more muscles. Exercises directed to such muscles will help to strengthen the muscle. While exercises may target one muscle, generally they may target more than one muscle. Preferably, once a true weakness is identified, the weak muscle or muscles are exercised either essentially alone or with other muscles. In determining which exercises are best for a subject, all test information may be taken into account.

### Reassessment

The present method uses dynamic reassessment techniques. Once a test is performed and tissue is identified as restricted; then the restricted tissue is palpated for localized restrictions; and then the localize restrictions released through manual pressure; the test is reperformed, to determine whether the tissue still tests as restricted (ie subject cannot maintain the test position), and preferably reperformed until the tissue no longer tests as restricted and the subject can maintain position. In between tests and after release, the subject is preferably instructed to leave the test table and walk around, swing arms, perform exercises relevant to the previously restricted tissue. Subjects sometimes refer to their muscles as feeling “light” after one or more release and testing sessions, and often find it easier to perform exercises targeting a specific muscle after a release than before; and easier after two releases than one release; and so forth. If a true weakness is discovered, as described above, and activation occurs, subjects may describe similar sensations.

After evaluation according to the present invention, a subject is preferably reassessed weekly, monthly, or yearly, to ensure continued performance of targeted exercises. In some cases, reassessment may be helpful in updating muscles identified as in need of activation and exercise, as the body accommodates changes in muscle use, or even in some cases for medical reasons such as considerations relating to surgery.

The present invention relates in part to a method for training a tester how to use the above method, and in particular how to restore or maintain balance of a subject's body. All information in this application may be applied in training an individual to work with a subject's body according to the present invention. The training method comprises training a tester, preferably a physical therapist, to work with a subject's body according to the present invention. Such working with the body includes at least training on how to evaluate at least one of a subject's upper body and a subject's lower body, said evaluating comprising the steps of (a) performing tests on a subject, wherein in each test the subject assumes a test position and a tester then attempts to move the subject from the test position, and then (b) considering the subject's ability to maintain the test position; wherein said tests for evaluating the subject's lower body comprise (i) a supine bilateral hip abduction test, (ii) a supine straight leg raise test, (iii) a prone straight leg raise test, and (iv) a side-lying leg raise test; and wherein tests for evaluating the subject's upper body comprise (i) a supine shoulder adduction test, (ii) a supine horizontal shoulder adduction test, (iii) a side-lying horizontal abduction test, (iv) a side lying shoulder abduction test, and (v) a prone shoulder horizontal abduction test and a prone elbow extension test. Said evaluation further comprises

All training is preferably done in person, with lecture and workshops so that students can gain hands-on proficiency in the methodology.

FIG. 39 shows a diagram detailing an embodiment of the method of the present invention.

The invention also relates to an instructive course, comprising at least one of written material, audio material, and/or video material describing how to perform a method of working with a subject's body according to the present invention. Course materials comprise information relating to performing necessary steps of the present invention. Preferably, the course materials are accompanied by live or video instruction on how to work with a subject's body according to the present invention; preferably, live instruction, more preferably by an experienced tester; more preferably where the experienced tester is a physical therapist. Goals of the course and of training a tester include in part the learning of dynamic assessment skills (for instance but not limited to testing, releasing and retesting restricted tissue); identifying where restricted tissue and other problems may exist in a subject's body; learning to perform necessary tests in the overall proper order to avoid being misled by misdiagnosis or various symptoms exhibited by the subject; developing superior palpation skills; understanding how the body compensates for weakness and restriction in tissue and how to address problems presented; developing appropriate release skills; and learning appropriate activation and targeted exercises for use on a given subject.

As mentioned above, exercises of specific muscles or groups of muscles are known in the art, and may be used for the purposes of activating and/or exercising a muscle showing a true weakness according to the present invention. Several exercises are described below. Exercises using equipment such as small or large balls, pilates equipment, foam rollers, and so forth, are acceptable for the purposes of the present invention. Generally speaking, arms and legs are preferably at rest unless they are engaged in exercise.

Preferably, an exercise according to the present invention includes from 1-5 sets of 5-20 repetitions of the exercise, per session. More preferably, the exercise includes from 2-4 sets of 8-16 repetitions; even more preferably, 3 sets of 10 repetitions. The exercise session is preferably performed 1-21 times per week, also preferably 1-3 times/day; and preferably, for 1-52 weeks. More preferably, an exercise session is performed 2 times per day, 3 sets of 10 repetitions. Also preferably an exercise session is performed every day for 1-15 weeks, more preferably for 1-6 weeks, most preferably for 1-4 or 2-4 weeks. The below exercises may be described in terms of one repetition, but are preferably repeated as indicated above. Generally, one repetition of an exercise includes starting and ending in the same position. A starting or other position achieved during these exercises may be held for instance for 1-20 seconds, preferably 2-15 seconds, most preferably 5-10 seconds.

Muscles that are exercised by the present exercises are indicated below. The skilled person will understand that small changes in movement may result in the exercising of different muscles. The below exercises may be used in particular for activation and/or exercises according to the present invention. Further descriptions of these exercises may be found in the copending US provisional application entitled “ACTIVATION AND/OR TARGETED EXERCISES”, incorporated by reference herein in its entirety for this purpose. Kegel Ball Squeeze: The subject lies on his back, with unarched back flat to the floor, knees bent at about 90 degrees, feet flat on the ground, with a small medicine ball between the knees. See FIG. 19. The subject squeezes ball, holds, and repeats. Optionally and preferably, the subject also kegels, holds, repeats. The subject may also push up through the heels and bring the subject's bottom off of the floor, into a bridge position, with shoulders and upper back still flat on the floor, and then perform the above movements. Also in the alternative, the subject may lie on his back as in the first position mentioned above, and preferably with the medicine ball between his knees, bring the knees to the chest in a slow and controlled motion, then hold and repeat that movement. The above exercises in particular exercise the rectus abdominis, pelvic floor, hip adductors and transverse abdominus.

Adductor Squats: The subject stands upright with feet shoulder width apart and pointed out at about a 45 degree angle, with weight distributed through the heels. See FIG. 20. The subject then brings his hips back, as though attempting to sit in a chair that is too far behind him, and squats down, forcing his knees out and away from the center of the body, as low as he can go. The subject then pushes back up through his heels, to the initial position. This exercise in particular exercises the hip adductors, gluteus maximus, and vastus medialis.

In another variation of the adductor squat, the subject stands upright with feet shoulder width apart and pointed out at about a 45 degree angle, with weight distributed through the balls of the foot, and heels off the floor. The subject then squats and pushes up as indicated above, keeping heels elevated throughout. This exercise in particular exercises the hip adductors, gluteus maximus, vastus medialis and gastrocnemius.

Adductor Slide: The subject stands upright with one foot on the floor and the other foot on a slide disc, approximately shoulder-width apart, slack in knees, weight through the heel. The subject then slides his foot with the disc out, away from the other foot, with even weight distribution between both legs, as though performing a center split. The foot is then slid back to the initial standing position. As a variation, this exercise may be performed with weight distributed through the balls of the feet at the starting position, knees locked, quadriceps tightened. For either exercise, if the movement is felt high in the groin area instead of in the adductor muscles, the subject's shoulders should twist toward the leg that is moving. These exercises in particular exercise the hip adductors and, when weight is on the balls of the feet, the vastus medialis oblique (VMO) as well.

Golf Ball Pick Up: The subject stands on one leg, back straight, and moves the other leg approximately one step behind the standing leg and digs toes and ball of foot into the ground, heel up, slack in the knee and with all weight on the standing leg, in the heel. Keeping his back straight and flat, the subject hinges from the hips and brings his torso forward, leaning toward the floor with arms hanging slack and as though ready to pick up an object, until the back approaches the horizontal. The subject's back does not arch nor shoulders shrug forward. The knee on the front standing leg will bend somewhat with the forward movement. The subject than stands back up. This exercise in particular exercises the hamstring muscles. As a variation, the subject may lock the knee of standing leg, tightening the quadriceps muscle and keeping the leg straight during the exercise. This exercise will exercise the gastrocnemius muscle of the calf.

Good Mornings: The subject stands with feet shoulder width apart, slack in knees, with feet turned inward, and weight through the heels. Keeping his back straight and flat, the subject hinges from the hips and brings his torso forward, toward the floor, until the back approaches the horizontal. The subject's back does not arch nor shoulders shrug forward. The subject's knees will bend slightly during this exercise, and are not to be locked. The subject than stands back up. This exercise in particular exercises the medial hamstrings. See FIG. 21.

In the alternative, the subject performs the above exercise with feet straight instead of turned in, to exercise the hamstring muscles. Also in the alternative, the subject performs the above exercise with feet turned out at about a 45 degree angle instead of turned in, to exercise the lateral hamstring muscle.

VMO activation squat: The subject stands on one leg and moves the other leg approximately one step behind, toes and ball of foot on floor and heel up, slack in the knee with weight through the heel. All weight should be on one leg at a time. The subject will then squat down on the front standing leg, forcing the knee out and shifting weight to the ball of the foot and then stand back up, keeping the knee forced out throughout the repetition(s), set(s) and session(s). This exercise in particular exercises the vastus medialis and gluteus maximus muscles. See FIGS. 17A and B.

Lunge Squats: In one lunge squat, the subject starts in a split stance as shown in FIG. 22, one foot in front and one foot behind, with weight through the ball of the front foot with the heel up and the front knee directly over the ankle. The subject bends both knees, preferably forming two 90 degree angles with the knee bends, bringing the back knee toward the floor preferably without touching the floor. The subject then presses up, remains on the ball of the front foot throughout the exercise. This exercise in particular exercises the hamstrings, gluteus maximus, gluteus medius, quadriceps and gastrocnemius muscles.

Other lunge squats may be employed as exercises according to the present invention, including a lunge squat with a trunk rotation, with weight on the front foot either on the ball of the foot (heel raised), or with the front heel pressed into the floor throughout; a lunge squat with a side bend; cross-legged lunge squats with arms reaching forward or with trunk rotation (again with weight on the heel or the ball of the front foot), and so forth.

“Nose To Wall”: The subject stands on one leg and positions the other leg as shown in FIG. 23. The standing leg is locked, quadriceps tightened, with all weight on the standing leg. Keeping the body straight, foot of the standing leg remaining flat on the floor, the subject shifts his weight from heel to ball of the foot of the standing leg, then shifts back again. The movement is shown in the Figure as moving the body toward the wall. This exercise in particular exercises the gastrocnemius muscle.

“Calf Raises”: The subject stands with chest against a stability ball which is rested on a wall, both legs straight out behind until the subject's heels are not touching the floor, as shown in FIG. 24. The subject preferably shifts his weight all to one leg to continue, lifting one leg off the ground, with the option of resting the lifted leg on the weight bearing leg. The subject then lifts onto the toes of the weight bearing leg, coming all the way back down almost until the heel touches the floor before repeating. The subject's knee of the weight bearing leg is bent at all times, and foot position of the weight bearing leg may be varied by keeping toes pointed toward the wall, pointed outward and pointed inward. To decrease difficulty, both feet may remain on the ground during this exercise. This exercise in particular exercises the soleus muscle. In another variation, the heel of the weight bearing leg is on the floor before raising up to toes—this variation exercises the gastrocnemius muscle.

Toe Taps: The subject stands with his weight all in one leg, for instance the left leg, in the heel of the foot, and slack in the knee, facing forward. The right leg is then moved left across the body, with the outside of the foot and small toe tapping approximately in front of the left shoulder. The right leg then swings back, opening the body up and tapping the big toe in front of the body a little past shoulder-width. Then, the right leg taps toes to the front and then to the back of the body, trunk still facing forward. Finally, the right leg is brought again in front and across the body to tap the small toe and side of foot, with the trunk twisting to accommodate the movement, and then brought behind the body, with the trunk moved sideways to accommodate. This exercise in particular exercises the gluteus maximus, gluteus minums, gluteus medius and ankle mobility. See FIG. 29.

Supine Straight Leg Raise: The subject lies on the floor with back flat (no arch), one leg straight and one leg bent with foot flat on the floor. The subject tightens the quadriceps of the straight leg and slowly brings the leg up to the height of the knee of the opposite leg, then preferably holds that position for 1-15 seconds. The straight leg is lowered again to the floor. This exercise particularly exercises the quadriceps muscles. If performed with lower leg in external rotation and foot in dorsiflexion, the exercise particularly exercises the vastus medialis.

Clams: The subject lays on one side, knees bent at 45 degrees, legs and heels stacked together. The upper body is largely at rest, upper arm preferably resting on the floor in front of the trunk, lower arm either on the floor with head and neck approximately on top, or bent with hand cupping head and neck to support. Preferably, a resistance band is positioned around and just above the knees. The subject keeps heels together and pushes bottom leg into floor while bringing top leg up, opening at the knees. The position may be held for instance 1-15 seconds before returning to original position. The pelvis is not to move forward or backward. The gluteus medius muscle is exercised through this exercise. As an alternative, the subject may exercise the gluteus medius muscle through a Monster Walk, in which the subject (preferably with resistance band around the middle of each foot) side steps far wide and then returns to the start position, all the time maintaining resistance.

Pelvic Tilts (anterior/posterior): The subject may shift the pelvic region forward and backward, for instance by sitting on a large exercise ball, chest upright, shoulders down and back, back straight, feet hip width apart and flat on the floor. Maintaining an upright posture throughout, the subject shifts his hips forward, flattening the lower back, and then shifts hips backward, arching the back. As a variation, while sitting on the ball, the subject may slowly lift one foot off the ground, maintaining knee bend at 90 degrees, then preferably hold 3-5 seconds and return to starting position and the other leg also lifted for a full repetition. The transverse abdominus is particularly exercised through these exercises.

Supine Transverse Abdominus March or Fallout: The transverse abdominus may also be exercised by the subject lying flat on his back (no arch), knees bent at 90 degrees with feet flat on the ground, arms relaxed to the side. The subject shifts his belly button toward his spine, flattening the relevant area. March: The subject slowly lifts one foot off the ground, maintaining 90 degree knee bend, moving the knee toward the chest. Preferably hold for 3-5 seconds. The leg is then returned to original position and preferably the exercise repeated with other leg. A repetition for this exercise includes one right and one left leg raise. Fallout: The subject slowly drops one leg to the side, maintaining knee bend at 90 degrees, feet still flat on the ground. Leg is slowly returned to original position and repeated on opposite leg for a full repetition.

Bird Dog/Quadruped: Single Arm Raise: The subject starts on hands and knees, knees directly under hips and wrists directly under shoulders, maintaining a neutral spine (no arching or rounding of back). One arm is raised up until parallel with the ground, preferably held 3-5 seconds, then lowered to original position and other arm raised and lowered for a full repetition. This exercise exercises in particular the latissimus dorsi, erector spinae and lower trapezius. Single Leg Raise: Starting in the same position as above, arms remain in place while one and then the other leg is raised until parallel with the ground, and preferably held for 3-5 seconds before returning to all fours. This exercise exercises in particular the gluteus maximus and erector spinae. Alternating Arms and Legs: The subject raises one arm and the opposing leg as indicated above, holding each parallel to the ground preferably for 3-5 seconds before returning to original position and raising the other arm/opposing leg for a full repetition. This exercise exercises in particular the latissimus dorsi, erector spinae, lower trapezius and gluteus maximus. See FIG. 25.

Side bending abdominals: A variety of abdominal exercises include side bends, with the subject standing straight and tall, feet slightly wider apart than hips, weight evenly distributed between both legs, preferably with one arm lowered to grasp a pulley with weights to provide extra resistance for the movement, and opposite arm bent with hand behind head. The subject then bends at the hips to the side, away from the weight, then back to starting position. This exercise particularly exercises the quadratus lumborum and external oblique. As a variation, one leg may be placed approximately one step behind the trunk, with toes and ball of foot supporting and heel up, before performing side bend. This exercise targets the quadratus lumborum and internal and external obliques.

Side plank: The subject lays on one side, places elbow under shoulder and engages the abdominal muscles and gluteus muscles. The subject pushes up, supporting the body's weight with the forearm and side of the foot. With heels stacked and flat back, the position is preferably held before release. See FIG. 26. As a variation, the hip may be dipped down toward the ground. This exercise targets the internal oblique, external oblique and quadratus lumborum.

Prone Plank: The subject lays on stomach, placing elbows under shoulders and tightening/engaging abdominal muscles and squeezing gluteus muscles together. The subject then pushes up onto forearms and toes so subject's body is parallel with the ground, keeping elboys under shoulders, and making certain back is flat. The subject holds the position, then relaxes. See FIG. 31.

Wall Dips: Side: The subject leans with one arm against a wall, palm of hand pushing against the wall, shoulder and arm rotated so elbow is straight and fingers point to the back. The other arm is at rest at subject's side, away from the wall. The leg closest to the wall is crossed in front of the far (weight bearing) leg. The subject raises the resting arm up to the side and over toward and preferably touching the wall, with hips moving away from the wall, dropping the shoulder of the weight-bearing arm. See FIG. 30. Front: The subject faces and leans against a wall, one arm extended out from the body, palm of hand pushing against wall, fingers facing out, feet hip width apart (optionally with bent knees). Without moving the weight-bearing hand, the knees bend and hips push back away from wall, with shoulders dropping down and back head and neck straight and preferably parallel or nearly parallel to the floor. These exercises exercise and activate in particular the latissimus dorsi and lower trapezius.

Standing Wall Angels: The subject stands with shoulder blades, head and lower back flat (no arch) against the wall; arms at a 90 degree angle such that elbows are about the same height as shoulder blads. If necessary, feet may be brought away from wall and knees may be bent for back to be flat against the wall. The subject's arms are then raised so elbows are above shoulders and arms form a “U” shape above the subject's head, with wrists and elbows touching or nearly touching the wall. Then, the subject's arms are lowered back to the 90 degree angle, pinching shoulders down while lowered. This exercises in particular the middle trapezius, lower trapezius, rhomboids and latissimus dorsi.

Elevated Push-ups: The subject stands facing a bench or table or other raised surface, abdominal muscles engaged. The subject places hands, fingers facing out and palms down, on the edge of the surface, shoulder width apart. The subject then walks his feet away from the bench until his body is straight. His feet may be together or apart. The subject then bends his elbows to slowly lower his chest to the edge of the surface, keeping his body rigid, elbows close to the body and wrists under shoulders throughout the exercise. Once lowered, the subject pushes his body back up to the starting position. As a variation, the elevated push ups may be performed with a stability ball instead of a raise flat surface; with hands placed on either side of the ball, fingers facing out, palms down. These exercises target the pectoralis major and serratus anterior muscles.

Supine Chin Tucks: The subject lays on his back, flat on the floor (no arch), knees bent to 90 degrees and feet flat on the floor, with head touching the ground. Maintaining eye level, the subject brings the chin toward the ground, and holds it for 5-10 seconds, preferably. This exercise targets the deep cervical flexors.

Pendulums: The subject, standing upright, hinges forward from the hips and supports the body by holding an arm straight on a chair, as shown in FIG. 27. The other arm hangs freely and relaxed off and away from the chair. The subject lightly rocks the body side-to-side, front-to-back, and/or in circles (preferably all three), allowing the arm to swing freely. The exercise should be repeated on both sides. This exercise targets “range of motion” muscles.

Wall crawls: “Range of motion” muscles may also be exercised for instance by standing facing a wall, and slowly walking fingers up the wall as high as possible, then holding for instance for 3-5 seconds, and then slowly walking fingers down the wall to return to starting position. One repetition refers to performing this one time with each arm.

Standing Ball Circles: The subject stands up straight, an arm's length away from a wall, and squeezes his shoulder blades down and back. Holding a small ball against the wall, the subject leans into the ball (arm straight, elbow locked) and rolls the ball in clockwise and counterclockwise circles. This exercise targets the rotator cuff: supraspinatus, infraspinatus and teres minor.

Side-lying Shoulder Abduction: The subject lays on one side, knees bent at 90 degrees, hip stacked over hip and shoulder stacked over shoulder, with top arm rested on the top side of the body and lower arm for instance supporting head. The subject slowly brings his arm up toward the ceiling, and preferably holds there 3-5 seconds, before lowering again. This exercise targets the deltoid and supraspinatus muscles. In a variation, as shown in FIG. 28, the top arm starts in front of the body as shown, thumb up toward ceiling, preferably with a barbell as shown. The subject then moves the arm up toward the ceiling, and preferably holds the position for 3-5 seconds before lowering, preferably for another repetition.

Supine Serratus Anterior Punch: The subject lies flat on his back (no arch), shoulder blades also on the floor, knees bent at a 90 degree angle, feet flat on the ground, head touching the ground, arms extended straight up above the shoulders with locked elbows. The subject preferably holds a weight in both hands, and punches arms up toward the ceiling so that the shoulder blades lift off the ground, while head remains in contact with the floor. Preferably, the subject holds this position for instance 3-5 seconds before lowering shoulders to the floor. This exercise targets in particular the serratus anterior.

Standing Shoulder exercise with Internal Rotation: The subject stands upright, both arms at sides, one arm bent at elbow to about 90 degrees, feet shoulder width apart with slack in knees, abdominal muscles engaged, thumbs up with forearm straight out and shoulders down and back. The bent arm preferably holds a resistant band which is pulling straight to the side and away from the body. The subject places a rolled up towel in between his elbow and side. The subject then slowly moves his arm toward his stomach while maintaining the bend in the arm and while continuing to hold the towel between elbow and side. This exercise targets the subscapularis muscle. See FIG. 29, showing the exercise performed with a resistance band.

Bicep Curls with Scapula Pinch: The subject stands tall, abdominal muscles ingaged, feet shoulder width apart, slack in knees, shoulders down and back, holding dumbbells at sides, arms straight, palms facing out. The subject then brings shoulder blads together, keeping elbows back and bending arms up to chest height, keeping dumbells next to body (touching sides) throughout the exercise. Elbows pinch back and shoulder blades squeeze together, preferable for a 5 second count, and then a return to starting position. See FIG. 33A, B.

Latissimus Dorsi/Quadratus Lumborus Stretch with Stability Ball: The subject kneels tall on the floor in front of a stability ball, placing hands on top of the ball, and sitting back on heels without moving the ball toward himself. The subject drops his chest towards the ground until he feels a stretch, then holds the position and relaxes, then repeats. After performing sets in the straight position (A), the torso may be rotated left (B) and right (C) for a deeper stretch. See FIG. 34.

Stability Ball Push-Ups: The subject places a stability ball against a wall, abdominals engaged, placing hands (fingers facing out, palms down) shoulder width apart on top of the stability ball and walking feet away from the ball until the body is straight. Feet can be together or apart. See FIG. 35A. In FIG. 35B, the subject bends elbows to slowly lower the chest to the ball, keeping the body rigid, elows close to the body and wrists under shoulders throughout the exercise. The subject then pushes his body back to starting position A.

Twisting Lats (thumb out-up-in): The subject sits on a stability ball, chest upright, shoulders down and back, abdominals engaged, feet hip width apart and flat on the floor. One arm extends out in front (with locked elbow, parallel to the ground), holding the resistance band or cable. The subject twists away from the fixed point, increasing resistance. The subject then pinches his shoulder in towards the spine at the end range and holds, slowly releasing to start position. See FIGS. 36 A, B. FIGS. 36 C, D and E show hand positions for this exercise, starting with thumb out, then thumb up, and finally thumb in.

Pectoralis Stretch Corner: The subject stands facing the corner, bringing arms up to shoulder level. Placing one arm on each side of the wall, elbows bent at 90 degrees (forearms, elbows and hands against the wall, fingers towards ceiling) the subject then leans his body weight in, bringing chest closer to the wall until he feels the stretch in his pectoral muscles. Then relaxes. See FIG. 32.

Other exemplary exercises according to the present invention may include bicep curls (exercising biceps brachii, rhomboids and latissimus dorsi); arm rows and bow-and-arrow movements (exercising the latissimus dorsi and rhomboids).

While a variety of exercises are acceptable for activation purposes, and more for targeted exercise thereafter, preferred activation exercises and targeted exercises of the present invention are as follows, for instance for muscles showing a true weakness or identified as latent:

For the iliacus or psoas muscles: FIG. 22.

For the iliacus muscle and quadriceps: FIG. 22 with legs shoulder-width apart.

For adductor muscles: FIG. 20.

For the TFL and vastus lateralis: FIG. 22 with legs crossed (right foot inside and back foot outside).

For quadriceps and the vastus intermedialis: FIG. 22 with a focus on the back leg

For quadriceps muscles vastus medius and vastus medialis oblique: VMO Activation Squat of FIG. 17

For distal lateral quadriceps (vastus lateralis): FIG. 22, with weight on the ball of the foot of the front leg (advanced: heel raised of front foot raised)

For lumbar paraspinals and quadratus lumborum: FIG. 22, with pelvis tucked under

For abdominals: deep diaphragmatic breathing and FIG. 20

For gluteus maximus: FIG. 22, with subject reaching forward with arm on same side as front leg, weight on front heel.

For sacroiliac ligaments: FIG. 22, with subject reaching forward with arm on same side as front leg, weight on front heel.

For gluteus medius and/or minimus: FIG. 21 with feet turned out, heels together (close but touching not required)

For adductors or hamstrings: FIG. 20 or FIG. 21

For the distal hamstring: FIG. 20 with feet straight and weight on the ball of the foot, to activate and lengthen.

For the distal bicep femoris and/or posterior knee: FIG. 21, knee bent, weight on ball of foot, legs and feet straight For the gastrocnemius muscle: FIG. 21, knee bent, weight on ball of foot, legs and feet straight.

For the distal lateral hamstrings: To Lengthen (1) feet turned out, weight on balls of feet (heels together), FIG. 21. Also (2) preferably activate upper hamstrings so also do variation of FIG. 21 with weight on heels, feet turned out, heels together.

Exercises not shown may be seen in the copending US provisional application entitled “ACTIVATION AND/OR TARGETED EXERCISES”, filed Mar. 15, 2013. The muscle grouping above roughly correspond to the order of Lower Body and Upper Body Tests described in the application, to show exemplary activation exercises where a true weakness is revealed by a given test. The skilled person will understand that variations may occur.

WORKING WITH THE BODY TO PROVIDE WELLNESS, PREVENTION, TREATMENT AND BODY MAINTENANCE

The method of the present invention may serve a variety of purposes for a subject. A subject undergoing evaluation of at least one of the subject's upper body and the subject's lower body, simply by having the necessary tests performed and considered, may gain valuable information regarding his/her body musculature at a local level and in terms of overall balance of the body. Even if no restrictions are found and the subject's body is found to be balanced, the tests and basic results may contribute to the subject's health and wellness, including the subject's sense of health and wellness. The performance of further steps, where restricted tissue is identified, localized restrictions located, and then released; reassessment performed and ultimately any true weakness or latent muscles realized, is preferable and may further contribute to the subject's health and wellness, including the sense thereof.

The present method may similarly be useful for the purpose of body maintenance. A subject undergoing the necessary tests and showing no restricted tissue and/or good overall body balance will know he/she is exercising or otherwise moving properly, and can maintain personal maintenance habits (for instance, yoga, exercise regimens, even no regimen at all). Where restricted tissue is identified and other steps of the method are performed, including locating and releasing localized restrictions and, where appropriate, a true weakness in a subject's body, then application of activation and targeted exercise of the present method may further aid in good body maintenance. The subject may begin to understand the effects of his activities (or lack thereof) on his body, and act to keep the body balanced, to avoid situations that may make the subject prone to injury.

The present method may also be useful for the prevention of injury, as discussed throughout this application, for instance for the person of normal activity; the office worker that sits for prolonged periods of time; the athlete with a demanding physical regimen. By testing the body, preferably regularly, and discovering whether tissue is restricted and, if restricted, by finding and releasing localized restrictions and reassessing to identify any true weakness and latent muscles, and then activate and exercise such to preferably restore balance to the region and the body, the subject may minimize his/her chance of injury due to lifestyle choices.

Finally, the present method may be useful for the treatment of injury or pain, or for the diagnosis of a physical problem described by the subject.

### Balancing the Body

### Example 1

The method of the present invention was performed on a 42 year old female subject. The subject's goal was to supplement a new exercise regimen and to improve joint mobility. The subject's profession required prolonged sitting, and she voiced concern over long-term effects of many seated hours. At present she is able to sit for long periods of time without discomfort. Also, the subject indicated perceived changes in her feet and her pelvic area after delivery of a child 4 years before. The subject indicated occasional low back discomfort, loss of muscle tone, perceived loss of full-range of motion and occasional pain in the left ankle due to an old sports (tennis) injury.

Upon initial gross examination, when standing, the subject's left hip measured higher than the right hip. Range of motion in the subject's left ankle was limited. Also, a first metatarsophalangeal (MTP) valgus (a bunion) was identified on each foot, having a lateral deviation measuring 40 degrees on the left foot and measuring 22 degrees on the right foot, causing the large toe to angle (point) slightly toward other toes on the same foot. Upper and lower body tests were performed on the subject, and foot/ankle tests.

The subject was instructed by a person performing the following tests of the present method (“tester”) to lie supine on a lightly padded therapy table. The tester conducted the following tests on the subject. Each test is designed to isolate a muscle or group of muscles of interest. Throughout the tests, the subject marveled at her inability to maintain position despite her attempts to maintain position. The tests isolate restricted tissue and thus are able to show where e.g. muscle is restricted.
1. A supine bilateral hip abduction test was performed on the subject's leg, and then the subject's left leg. The tester applied pressure 2-3 times on each leg to determine the appropriate level of pressure for the subject. The subject was not able to maintain position with either leg. The psoas muscle was identified as restricted, and local restriction found via palpation and then released at an oblique angle of release of about 45 degrees on each side of the subject's body. (approximate angle between the subject's supine body and the tester's hands/fingers, pressing into the subject from above and to the side of the subject's body). Also upon palpation, restriction of the iliacus muscle was identified and said restriction released at an angle of release of about 90 degrees.
2. A supine bilateral hip flexion (straight leg raise) test was performed on each leg, at an angle of about 45 degree flexion.
   In neutral position (leg not rotated; leg raised with knee facing up), dorsiflexion, the subject did not fully maintain position in particular on the left side, with the right leg graded at 4+ and the left leg weak at 3+. The psoas muscle was identified as restricted.
   In external rotation position, the adductors, gracilis and sartorius muscles were tested. The subject did not fully maintain position in particular on the left side, with the right leg graded at 4+ and the left leg weaker at 3+.
   In internal rotation position, the ITB/TFL were identifed as restricted. The subject did not fully maintain position in particular on the left side, with the right leg graded at 4+ and the left leg weaker at 3+.
   In neutral, external rotation, and internal rotation leg positions, in plantarflexion, the subject did not fully maintain position on either side, with the right leg graded at 4+ and the left leg weak at 3+. The muscles tested for these positions are distal quadriceps (neutral position), distal adductors (external rotation) and distal ITB (internal rotation).
      The psoas and iliacus muscles were palpated to identify areas of local restriction. The tester released the psoas muscle and the iliacus muscle as much as possible by applying manual pressure directly to each muscle with the tester's hands, and by using active range of motion techniques such as hip flexion to help move and release each muscle. Also, the adductors, ITB/TFL and quadriceps were palpated and restriction identified and released in the TFL. Release of the psoas is believed to assist the transverse abdominus muscle to stabilize all movements. In the present case, after release of restrictions in the psoas and TFL, the straight leg test was performed again. The subject was better able to maintain position, and upon confirmatory palpation of the adductors and ITB/TFL, all restrictions deemed removed.

The subject moved off of the table and walked a brief while, and upon reassuming a supine position, was again tested according to the supine bilateral hip abduction test and supine straight leg test, and was able to maintain position for each leg throughout each test.
3. A prone straight leg test (resisted bilateral hip extension test) was performed in neutral, external, and internal leg rotation positions.
   The subject lay prone on the table and raised each leg, one at a time, about 45 degrees from the table surface. Muscles tested by neutral positions of this test (and other positions unless otherwise noted) include the gluteus maximus, erector spinae, hamstrings and “lats” (latissiums dorsii), acting together in combined motion. In neutral position (knee facing table), with foot in dorsiflexion and then in plantarflexion, the range of motion was limited and position not maintained on either side. In this and the other prone straight leg raise tests mentioned immediately below, the subject's ability to maintain position and resist the tester's attempts to move the leg out of the test position was 4− for each leg, each subtest below.
   in external rotation position (knee facing away from the body), with dorsiflexion of the foot, the poriformis muscle was tested in addition to the muscles mentioned above, and, the subject unable to maintain position. The piriformis muscle identified as restricted.
   In internal rotation, foot dorsiflexed, the gluteus medius was also tested and the subject unable to maintain position. The gluteus medius was identified as restricted.
   In external and internal rotation, foot plantar flexed, the muscles tested in neutral position were tested here, and as the subject was not able to maintain position.
   The above-mentioned muscles were palpated for restrictions and a restriction in the piriformis muscle identified and released. Upon repeating this test (including all 6 subtests), the subject maintained each test position to a level of 4+ but was found to continue to show limited range of motion. The tester encouraged hip flexion stretches on the subject and a C-R stretch, and found improved range of motion.
4. Side-lying leg raise tests were performed.
   The subject moved from prone position to the right side of the body, hips stacked, legs comfortably straight (not extended or bent), left arm resting atop the body and right arm resting under the body, so that the subject would not use the arm to stabilize the body. The test was first performed on the subject's top leg. Thereafter, the subject raised her left (top) leg, forming an angle of about 50 degrees with the table surface, and then raised her right (lower) leg about 20 degrees from the table surface, and was instructed to maintain position for each leg, and resist movement as opposing force is applied. The tester supported the subject's top leg while pressing on the lower leg, attempting to move the leg to the table. The test was also performed on the left side of the body.

Upper leg (abductor muscles, particularly gluteus medius, externally rotated): The subject did not maintain position for the upper leg during the first performance of this test, scoring a 4 on both the right and left legs. Abductor muscles were identified as restricted and palpated for local restrictions. Upon release of the restrictions, the upper leg side-lying test was again performed, and position maintained.

Lower leg (adductor muscles): During the first performance of this test on each leg, the right leg scored a weak 3+ on a 5 point MMT scale, and the left leg a weak 3. The adductor muscles were identified as restricted on each leg. The adductor muscles were palpated and local restrictions released. The lower leg side lying test was performed again and, upon presentation of the same weak score, adductor muscles on both legs again palpated and released. The test was performed several more times, and the right leg eventually was able to improve its ability to maintain position. However, although no further restrictions could be found in the subject's left leg adductor muscles, the subject's ability to maintain position and resist abductive force applied to the left leg during the lower side-lying test did not improve.

The adductor muscles were identified as showing a “true weakness”, and activated via vigorous manipulation and then by the subject undertaking 3 sets of 15 squats. The subject was asked to continue to do 3 sets of 15 squats as exercise every day for 1 week. The subject reported substantial tingling sensations in her inner left leg (adductor muscles) for approximately 2 hours after the test, and soreness in the leg for about 4 days, as though the muscle had been vigorously exercised. The subject reported such sensations were not noted in the adductor muscles of the right leg.
5. Performance of knee flexion test.
A knee flexion test was performed as described above. The subject was able to maintain position on both legs, and so no muscles were identified as restricted or having restrictions in view of this test.
   Ankle and foot tests were then performed.
6. An ankle test was performed.
   With the subject seated upright at the end of the therapy table, lower legs dangling or resting on available foot rests, the tester examined the left and right ankles of the subject. Both ankles revealed a potential inferior positional fault at the inferior tibiofibular joint and a lateral tilt, more pronounced on the left ankle, indicating a restriction in the lateral malleolear retinaculum.
7. A mid-foot test was performed.
   With the subject seated upright at the end of the therapy table, lower legs dangling or resting on available foot rests (each foot unsupported by anything but the tester during the test), the tester examined the mid-foot of the right and left foot of the subject. The examination included assessment of the talocrural and subtalar regions, as well as mobility of the mid-foot and first metatarsal. Soft tissue palpation was conducted to check for restrictions in for instance long plantar fascia (along the sole of the foot), posterior tibia tendon and FHL tendon (medial ankle), the peronei tendons (lateral ankle), extensor tendons (dorsum of foot) and intertarsal fascia.
8. A fore-foot test was performed, with first metatarsal phalange mobility assessed.

Rigorous maneuvering of the distal phalange, laterally with distraction, resulted in a reduction of the bunion from 40% identified during initial examination to 30%. A restriction in the plantar surface of the first metatarsal phalange joint was identified and released during plantar fore-foot examination.

### Upper Body Test

The following tests were performed, in the following order:

Supine Shoulder Adduction Test—the subject was unable to maintain position during the first test on the left side. A restriction in the left subscapularis muscle was identified and released. Thereafter, the subject was able to maintain position.

Supine Horizontal Shoulder Adduction Test—the subject was unable to maintain position during the first test on the left side and on the right side. Restrictions in the pectoralis muscles were identified and released. Thereafter, the subject was able to maintain position.

Supine Elbow Flexion Test—the subject was unable to maintain position during the first test on the left side. A restriction in the left biceps was identified and released. Thereafter, the subject was able to maintain position.

Side Lying Range of Motion Tests for Horizontal Abduction—the subject was able to maintain position on both sides.

Side Lying Range of Motion Tests for Shoulder Abduction—the subject was able to maintain position on both sides.

Prone Shoulder horizontal abduction Test of the present invention—the subject was able to maintain position on both sides.

Prone Elbow Extension Test—the subject was able to maintain position on both sides.

Shoulder Flexion Test—the subject was able to maintain position on both sides.

Abdominal Test—the subject was able to maintain position on both sides.

After testing, the subject advised of a tingling sensation in the left front part of the upper leg. The tingling was not painful. The subject later described soreness in the left inner thigh for 4-5 days after testing. The soreness was similar to that felt after extreme exertion—a “good burn”. Due to the soreness, the subject stated activation exercises were difficult to undertake at first, easier thereafter.

Overall, the adductor muscles showed a true weakness and were activated. The psoas muscle showed weakness as well, although not a true weakness. Activation and later targeted exercises: adductor squats and abdominal stretches. The subject reported difficulty in follow up exercises (3 sets/day adductor squats and abdominal stretches) for the first two days, due to soreness from activation, and little difficulty thereafter. The subject also reported perceived improvement in leg exercises over time, and satisfaction with the improved bunion angle, as the subject's “big toe” no longer made contact with its neighbor.

1. A method of working with a subject's body, comprising the steps of:
evaluating at least one of the subject's upper body and the subject's lower body; said evaluating comprising the steps of:
a. performing all tests in the order listed below on the subject's lower body and/or upper body, wherein in each test the subject assumes a test position and then attempts to maintain the test position while a tester attempts to move the subject from the test position, and then
b. determining whether the subject was able to maintain the test position;
wherein said tests for evaluating the subject's lower body comprise:
i. a supine bilateral hip abduction test,
ii. a supine straight leg raise test,
iii. a prone straight leg raise test,
iv. a side-lying leg abduction test; and
v. a side-lying leg adduction test,
and wherein said tests for evaluating the subject's upper body comprise:
i. a supine shoulder adduction test,
ii. a supine horizontal shoulder adduction test,
iii. a side lying shoulder abduction test, and
iv. a prone shoulder horizontal abduction test.

2. The method of claim 1, further comprising the following steps after said step b:
c. determining the subject was not able to maintain the test position,
d. identifying tissue that may be restricted in the subject because the subject was not able to maintain the test position, and then
e. palpating the identified one or more muscles to search for a muscle restriction.

3. The method of claim 2, wherein a muscle restriction is located.

4. The method of claim 3, wherein said restriction is released.

5. The method of claim 4, wherein after the restriction is released, at least steps a and b are performed again, and if after said considering step b it is determined the subject was not able to maintain the test position, then further performing steps d and e and, upon locating a muscle restriction, releasing said restriction.

6. The method of claim 5, wherein after removing all muscle restrictions, upon reassessment of a muscle or muscle group, the subject is again unable to maintain at least one test position and identified as having a true weakness in a muscle.

7. The method of claim 6, wherein said muscle showing a true weakness is activated.

8. The method of claim 7, wherein said activated muscle is exercised.

9. The method of claim 8, wherein after restrictions are released, the test is again performed to determine whether the subject maintains position.

10. The method of claim 9, wherein after completion of the method, the body is balanced.

11. The method of claim 1, wherein said evaluating the subject's upper body further includes the step of performing a supine elbow flexion step after said performing a supine horizontal shoulder adduction test and before said performing a prone straight leg raise test.

12. The method of claim 1, wherein said evaluating the subject's lower body further includes the step of performing a knee flexion test.

13. The method of claim 1, wherein said upper body prone test is at least one of the group consisting of:

14. The method of claim 1, wherein the subject's lower body is evaluated.

15. The method of claim 1, wherein the subject's upper body is evaluated.

16. The method of claim 1, wherein the subject's lower body and upper body are evaluated.

17. The method of claim 1, wherein a supine bilateral hip abduction test is performed, the subject is determined able to maintain position for one leg and unable to maintain position for the other leg, so that the iliopsoas muscle is identified as restricted on the side unable to maintain position, palpated and any restrictions released.

18. The method of claim 1, wherein a supine bilateral hip abduction test is performed and the subject is determined unable to maintain position for either leg, so that the psoas muscle is identified as restricted on the side unable to maintain position, palpated and any restrictions released.

19. The method of claim 1, further comprising continuing testing/all steps until all positions are maintained.

20. A method of training how to work with a subject's body, comprising the step of instructing a student to perform the method of claim 1.

21. An instructive course, comprising at least one of written material, audio material, and/or video material describing how to perform the method of claim 1.

22. The course of claim 21, further comprising live instruction on how to perform the method of claim 1.

23. A kit for performing the method of claim 1, comprising a list of required tests and a provision for recording test results.

24. A kit for performing the method of claim 20, comprising a list of required tests and a provision for recording test results.
